(19) United States
(12) Patent Application Publication
(10) Pub. No.: US 2014/0331840 A1
(43) Pub. Date: Nov. 13, 2014

(54) CUTTING MACHINE

(71) Applicant: MAKITA CORPORATION, Anjo-shi, Aichi (JP)

(72) Inventor: Toshiyuki Kani, Anjo-shi (JP)

(21) Appl. No.: 14/361,101

(22) PCT Filed: Oct. 30, 2012
(86) PCT No.: PCT/JP2012/077969

§ 371 Date: May 28, 2014

(30) Foreign Application Priority Data
Jan. 19, 2012 (JP) 2012-009165

(51) Int. Cl. B23D 47/02; B23D 45/04

(52) U.S. Cl. CPC B23D 47/02; B23D 45/042; B23D 45/044
USPC 83/471.3; 83/471.2

(57) ABSTRACT

The task is to achieve high cutting capability by using a simple configuration capable of maintaining a compact size and low cost. In a bench circular saw, a unit from a motor to a saw blade is provided as a separate member in a main body, and is held in the main body so as to be movable in a longitudinal direction at a lower limit position of the main body. A great cutting width can thus be ensured without the need to slide the entire main body in the longitudinal direction, namely by using a simple configuration in which only the unit is swung.

### TECHNICAL FIELD

The present invention relates to cutting machines such as bench circular saws.

### BACKGROUND ART

In cutting machines such as bench circular saws, a main body including a cutting blade that is driven by a motor to rotate is provided in a vertically movable manner above a base on which a workpiece is placed. The workpiece can be cut with the cutting blade by moving the main body downward (e.g., Patent Document 1).

Cutting capability (longitudinal dimension (cutting width) by which the workpiece can be cut) of such cutting machines is determined by the diameter of the cutting blade. Accordingly, conventional cutting machines, such as a slide circular saw disclosed in, e.g., Patent Document 2, includes a main body capable of sliding in the longitudinal direction so that the cutting machines can be used even for workpieces having a great cutting width,

### RELATED ART DOCUMENTS

### Patent Documents

[Patent Document 1] Japanese Patent Application Publication No. H08-332605 (JP H08-332605 A)

[Patent Document 2] Japanese Patent Application Publication No. 2010-228033 (JP 2010-228033 A)

### SUMMARY OF THE INVENTION

### Technical Problem

However, the main body capable of sliding in the longitudinal direction causes an increase in the overall size of the cutting machine, and the structure to be complicated, which results in an increase in the cost.

It is therefore an object of the present invention to provide a cutting machine capable of achieving high cutting capability by using a simple configuration that is capable of maintaining a compact size and low cost.

### Solution to Problem

In order to achieve the above object, the invention according to claim 1 is a cutting machine including a base, and a main body that is provided above the base so as to be movable in a vertical direction and includes a cutting blade driven by a motor to rotate. A unit from the motor to the cutting blade is provided as a separate member in the main body, and is held in the main body so as to be movable in a longitudinal direction at a lower limit position of the main body.

In the invention according to claim 2, in the configuration of claim 1, the unit is provided with a handle so that the unit is movable in the longitudinal direction along with an operation of moving the handle in the vertical direction.

In the invention according to claim 3, in the configuration of claim 1 or 2, the unit is held in the main body by attaching the unit to a portion of the main body other than the unit via a shaft so that the unit is swingable in the longitudinal direction.

In the invention according to claim 4, in the configuration of claim 3, a biasing member for biasing the unit to a front swing position is provided.

In the invention according to claim 5, in the configuration of claim 2, the handle protrudes forward of the unit.

### Advantageous Effects of the Invention

In the invention according to claim 1, a great cutting width can be ensured without the need to slide the entire main body in the longitudinal direction, namely by using a simple configuration in which only the unit is moved in the longitudinal direction, Accordingly, high cutting capability can be ensured even with a small cutting blade, whereby a compact size can be maintained and an increase in cost can be suppressed.

In the invention according to claim 2, in addition to the effect of claim 1, the unit can be moved in the longitudinal direction by the handle with satisfactory operability.

In the invention according to claim 3, in addition to the effect of claim 1 or 2, the unit can be moved in the longitudinal direction by using a simpler configuration because the unit is attached via the shaft.

In the invention according to claim 4, in addition to the effect of claim 3, in a normal state, the unit can be integrally fixed in the main body by the biasing member, which does not hinder normal use.

In the invention according to claim 5, in addition to the effect of claim 2, the use of the handle facilitates the operation of swinging the unit rearward.

### BRIEF DESCRIPTION OF THE DRAWINGS

FIG. 1 is a left side view of a bench circular saw.

FIG. 2 is a vertical section of a main body.

FIG. 3 is a plan view of the main body.

FIG. 4 is a right side view of the main body.

FIG. 5 is a right side view of the main body, in which a motor housing and a handle are not shown.

FIG. 6 is an illustration showing a swing range of a saw blade.

FIG. 7 is an illustration showing the state where the bench circular saw is in use (the main body is being moved downward).

FIG, 8 is an illustration showing the state where the bench circular saw is in use (the main body is located at a lower limit position and the saw blade is located at a front position).

FIG. 9 is an illustration showing the state where the bench circular saw is in use (the main body is located at the lower limit position and the saw blade is located at a rear position).

### DESCRIPTION OF EMBODIMENT

An embodiment of the present invention will be described below based on the accompanying drawings.

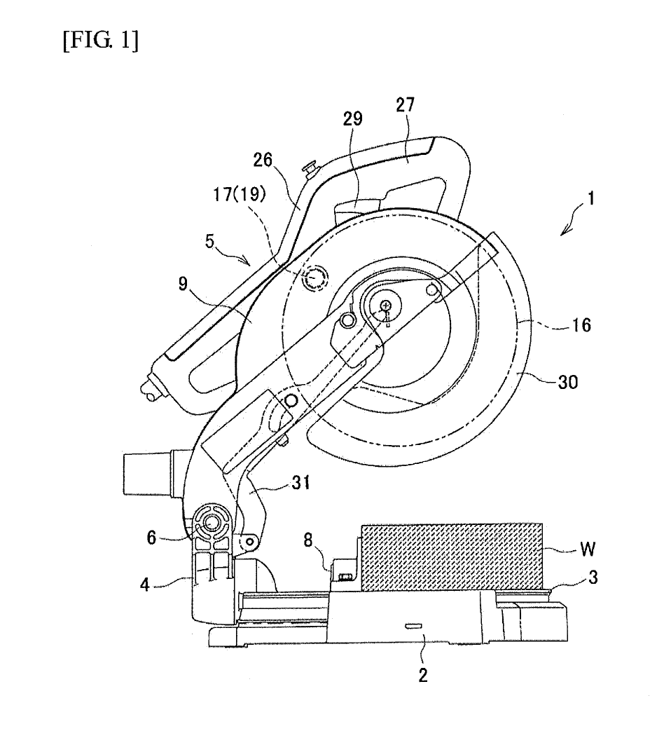

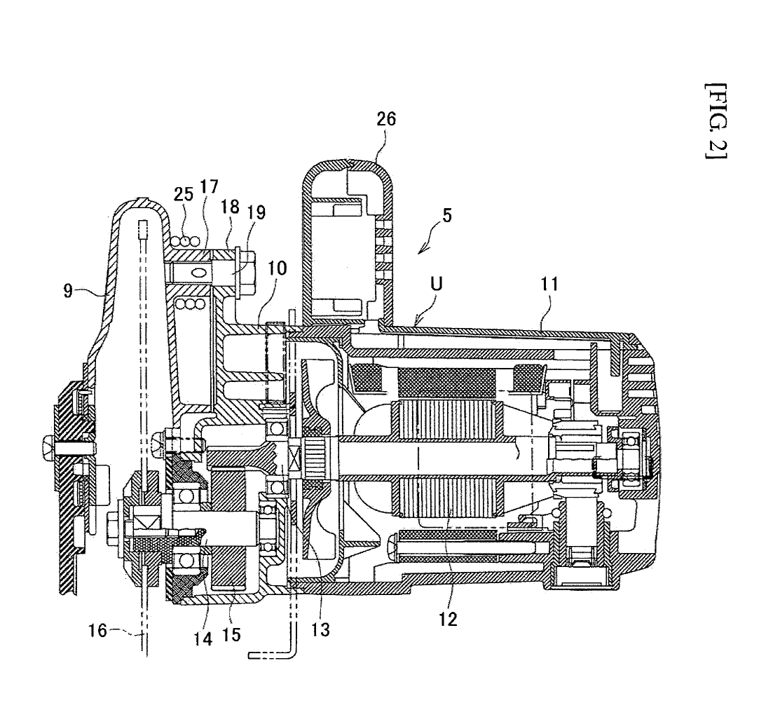

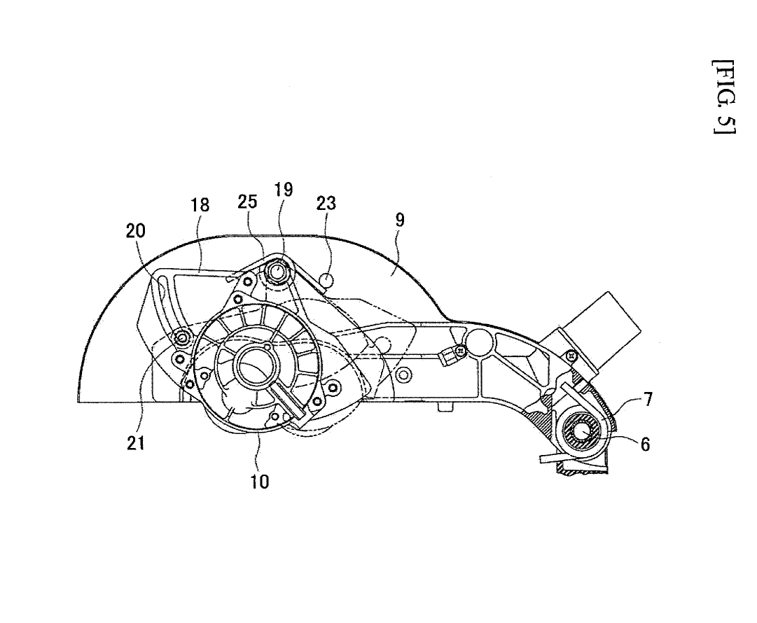

FIG. 1 is a left side view of a bench circular saw as an example of a cutting machine. In the bench circular saw 1, a turntable 3 whose upper surface is flush with a base 2 is placed on the base 2 so as to be rotatable in the horizontal direction, and an arm 4 that is rotatable about a longitudinal axis stands at the rear end of the turntable 3 (the right side in FIG. 1 is the front side). A main body 5 is rotatably attached to the upper end of the arm 4 via a lateral support shaft 6. In a normal state, the main body 5 is biased to an upper limit position shown in FIG. 1 by a torsion spring 7 (FIG. 4) provided on the support shaft 6. Reference numeral 8 represents a guide fence that stands on the base 2 so as to extend in the lateral direction and that is used to position a workpiece W.

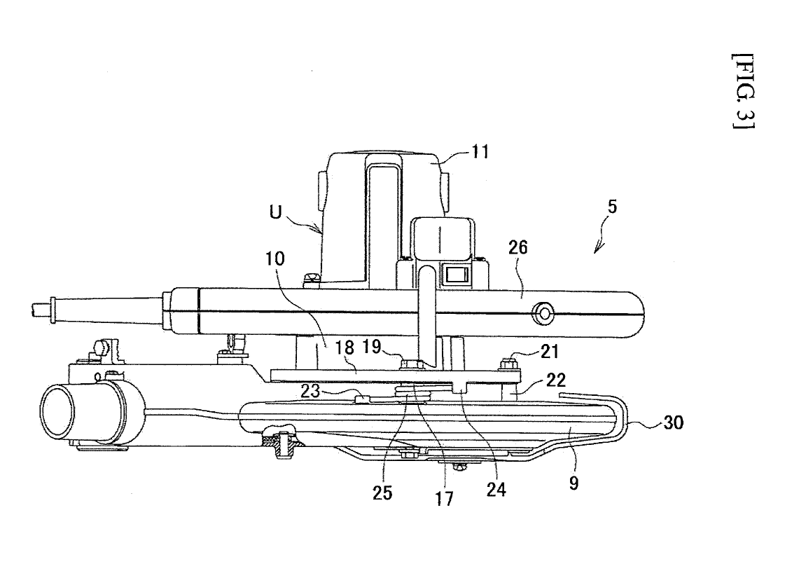

As shown in FIG. 2, the main body 5 includes a blade case 9 whose rear end is attached to the support shaft 6, a cylindrical gear housing 10 transversely coupled to a side surface of the blade case 9, and a cylindrical motor housing 11 coupled to the gear housing 10. A motor 12 is accommodated in the motor housing 11 such that its output shaft 13 protrudes into the gear housing 10, and a spindle 14 having a gear 15 meshing with the output shaft 13 is rotatably supported parallel to the output shaft 13 in the gear housing 10, and protrudes into the blade case 9. A disc-shaped saw blade 16 as a cutting blade is mounted on the tip end of the spindle 14 so as to extend perpendicularly to the spindle 14.

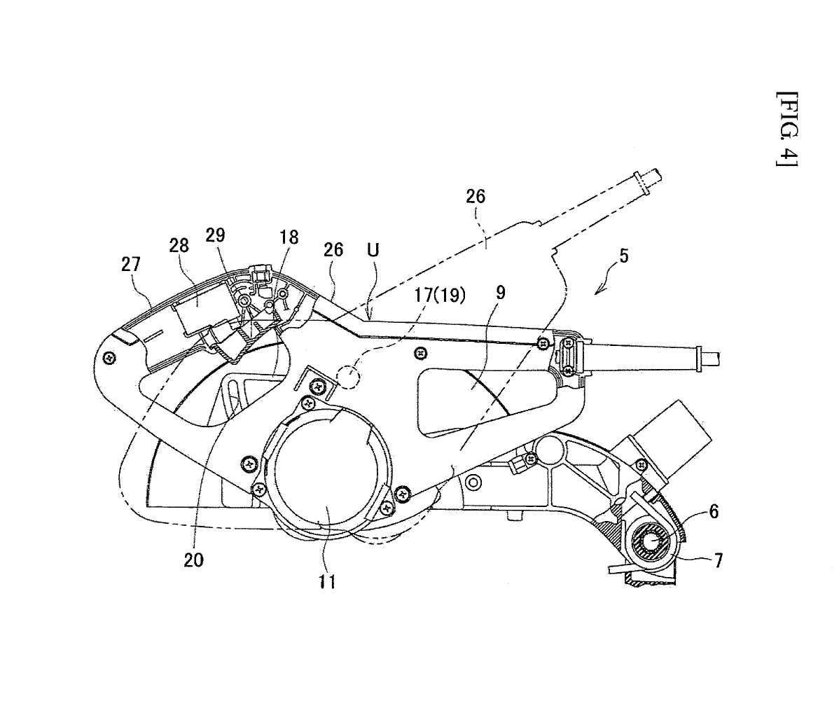

As is also shown in FIG. 3, the gear housing 10 is coupled to the blade case 6 by rotatably attaching a flange portion 18 provided along the periphery of the upper part of the gear housing 10, to a boss 17 protruding from the upper part of the side surface of the blade case 6, via a bolt 19. This allows a unit U as a portion from the motor 12 to the saw blade 16 in the main body 5 to longitudinally swing about the bolt 19 with respect to the blade case 6.

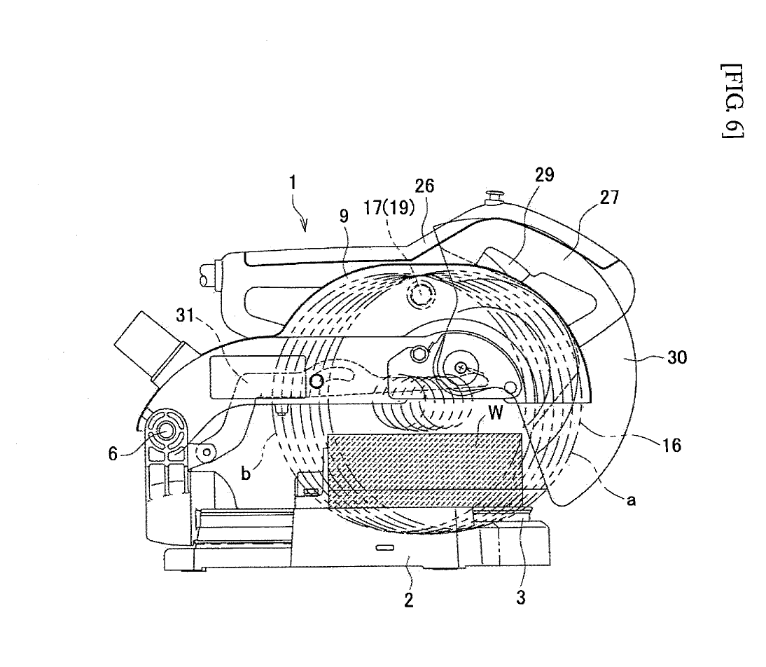

As shown in FIGS. 4 and 5, the flange portion 18 has a guide slit 20 formed so as to have an arc shape about the bolt 19, and a restricting bolt 21 extending through the guide slit 20 is screwed in a small boss 22 protruding from the side surface of the blade case 6. The unit U is thus held so that it can swing in such a range that the restricting bolt 21 contacts both ends of the guide slit 20.

Moreover, a torsion spring 25 is mounted on the boss 17. The torsion spring 25 serves as a biasing member and has its one end latched by a latch protrusion 23 of the blade case 6 and the other end latched by a latch protrusion 24 of the flange portion 18. In the normal state, the torsion spring 25 biases the unit U to a front swing position (position shown by solid line in FIG. 4) where the restricting bolt 21 contacts the lower end of the guide slit 20.

Reference numeral 26 represents a handle connected to the peripheral surface of the upper side of the motor housing 11 so as to extend perpendicularly to the motor housing 11. The handle 26 has a grip portion 27 formed at its front end such that the grip portion 27 is located forward with respect to the bolt 19 serving as a swing center. A switch 28 is accommodated in the grip portion 27, and the grip portion 27 is provided with a switch lever 29 that turns on the switch 28 by a pressing operation.

A safety cover 30, which covers the lower part of the saw blade 16 when the main body 5 is located at the upper limit position, is rotatably provided on the blade case 6. As the main body 5 is moved downward, this safety cover 30 rotates in such a direction that the saw blade 16 exposes, based on engagement with a link plate 31 provided between the safety cover 30 and the arm 4.

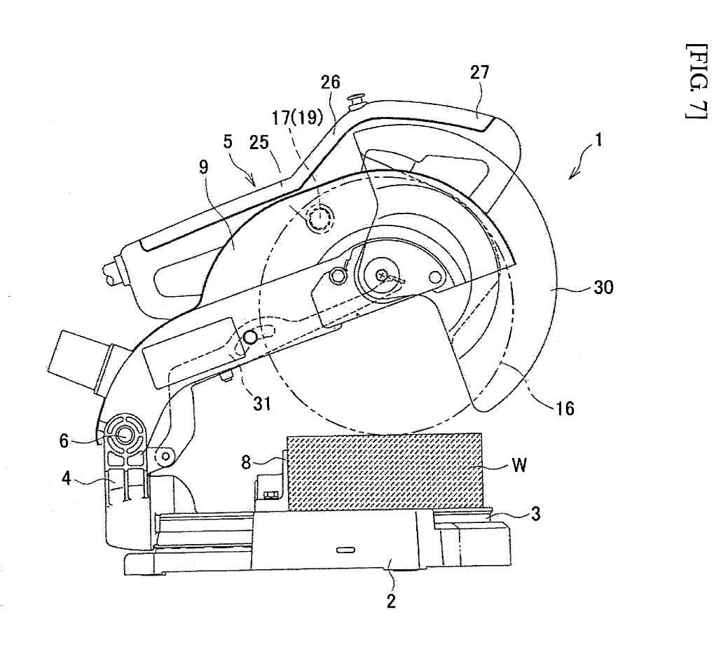

In the bench circular saw 1 configured as described above, when the main body 5 is moved downward to a lower limit position while holding the grip portion 27 of the handle 26 and, in this state, the handle 26 is rotated downward against biasing of the torsion spring 25, the unit U swings rearward about the bolt 19 with respect to the blade case 6. Accordingly, as shown in FIG. 6, the saw blade 16 also swings rearward from a front position shown by two-dot chain line “a” so that the center of the saw blade 16 is moved on an arc-shaped locus about the bolt 19. When the restricting bolt 21 contacts the upper end of the guide slit 20, the saw blade 16 reaches a rear position shown by two-dot chain line “b.” That is, the saw blade 16 can be moved in an arc-shaped pattern from the front position to the rear position.

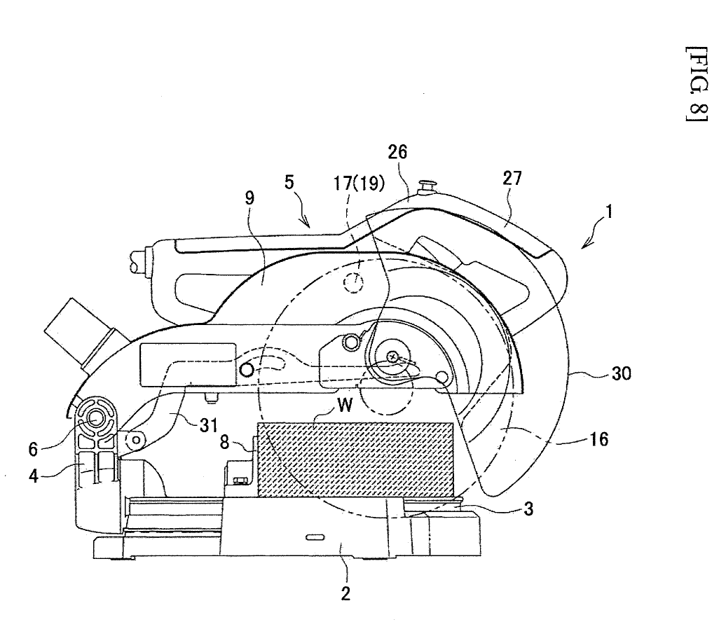

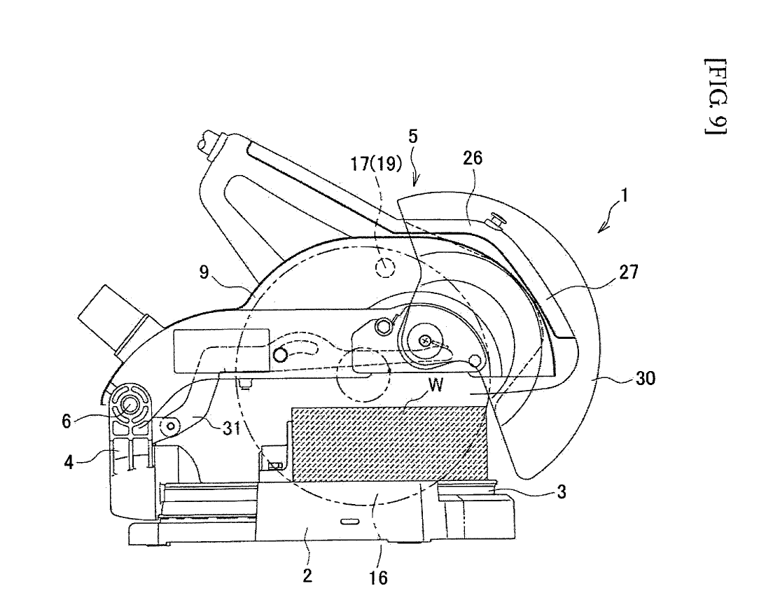

Thus, when the workpiece W is placed on the turntable 3 and the main body 5 is moved downward from the upper limit position shown in FIG. 1 while holding the grip portion 27, the safety cover 30 is rotated forward to expose the saw blade 16, so that the workpiece W can be cut with the exposed saw blade 16, as shown in FIG. 7. When the main body 5 continues to be moved downward, the main body 5 reaches the lower limit position, and the saw blade 16 is moved accordingly through the workpiece W and beyond the entire vertical length of the workpiece W, as shown in FIG. 8. However, if the workpiece W is long in the longitudinal direction, the workpiece W has an uncut part on its rear side in this state. Accordingly, the handle 26 is rotated downward from this state to swing the unit U rearward, as described above. Thus, the saw blade 16 also swings rearward together with the unit U, and the uncut part is cut as shown in FIG. 9. The workpiece W can be cut completely in this manner.

As described above, according to the bench circular saw 1 of the above embodiment, the unit U from the motor 12 to the saw blade 16 is provided as a separate member in the main body 5, and is held in the main body 5 so as to be able to swing in the longitudinal direction at the lower limit position of the main body 5. A great cutting width can thus be ensured without the need to slide the entire main body 5 in the longitudinal direction, namely by using a simple configuration in which only the unit U is swung. Accordingly, high cutting capability can be achieved even with the small saw blade 16. A compact size can thus be maintained, and an increase in cost can be suppressed.

In particular, in this example, the unit U is provided with the handle 26 so that the unit U can be moved in the longitudinal direction according to the operation of moving the handle 26 in the vertical direction. Accordingly, the longitudinal movement of the unit U can be made by the handle 26 with great operability.

The unit U is held in the main body 5 by attaching the unit U via a shaft to a portion of the main body 5 other than the unit U (the blade case 9) so that the unit U can swing in the longitudinal direction. Accordingly, the unit U can be moved in the longitudinal direction by using a simpler configuration.

Moreover, the biasing member (torsion spring 25) is provided to bias the unit U to the front swing position. Accordingly, in the normal state, the unit U can be integrally fixed in the main body 5, which does not hinder normal use.

The handle 26 protrudes forward with respect to the unit U. This facilitates the operation of swinging the unit U rearward.

In the above embodiment, the unit is made to be able to swing in the longitudinal direction by attaching the unit via a shaft to the blade case so that the unit can swing. However, for example, the unit may be held so as to be able to move linearly in the longitudinal direction by forming a longitudinal long hole in the flange portion of the gear housing so that the bolt can slide along the long hole. The unit need not necessarily be coupled by the bolt. The unit may be coupled to the blade case by a link mechanism such as a parallel link so that the unit can be held so as to be able to move in the longitudinal direction. In these cases, a coil spring, a leaf spring, etc. can be used as appropriate as the biasing member.

The present invention is not limited to bench circular saws, and may be applied to other cutting machines such as cutters. The present invention is even applicable to slide circular saws.

### DESCRIPTION OF THE REFERENCE NUMERALS

1: Bench Circular Saw, 2: Base, 5: Main Body, 6: Support Shaft, 9: Blade Case, 10: Gear Housing, 11: Motor Housing, 12: Motor, 13: Output Shaft, 14: Spindle, 16: Saw Blade, 17: Boss, 18: Flange Portion, 19: Bolt, 20: Guide slit, 21: Restricting Bolt, 22: Small Boss, 25: Torsion Spring, 26: Handle, 28: Grip Portion, 30: Safety Cover, U: Unit, W: Workpiece

1-10. (canceled)

11. A cutting machine, comprising:
a base; and
a main body provided above the base so as to be movable in a vertical direction, and including a cutting blade that is driven by a motor to rotate, wherein
a unit from the motor to the cutting blade is provided as a separate member in the main body, and is held in the main body so as to be movable in a longitudinal direction at a lower limit position of the main body.

12. The cutting machine according to claim 1, wherein
the unit is provided with a handle so that the unit is movable in the longitudinal direction along with an operation of moving the handle in the vertical direction.

13. The cutting machine according to claim 1, wherein
the unit is held in the main body by attaching the unit to a portion of the main body other than the unit via a shaft so that the unit can swing in the longitudinal direction.

14. The cutting machine according to claim 2, wherein
the unit is held in the main body by attaching the unit to a portion of the main body other than the unit via a shaft so that the unit can swing in the longitudinal direction.

15. The cutting machine according to claim 3, wherein
a biasing member for biasing the unit to a front swing position is provided.

16. The cutting machine according to claim 4, wherein
a biasing member for biasing the unit to a front swing position is provided.

17. The cutting machine according to claim 2, wherein
the handle protrudes forward of the unit.

18. The cutting machine according to claim 3, wherein
a guide slit having an arc shape about the shaft by which the unit is attached is formed in the unit, and a restricting bolt extending through the guide slit is screwed in the portion of the main body other than the unit, whereby the unit is held so as to be swingable in such a range that the restricting bolt contacts both ends of the guide slit.

19. The cutting machine according to claim 4, wherein
a guide slit having an arc shape about the shaft by which the unit is attached is formed in the unit, and a restricting bolt extending through the guide slit is screwed in the portion of the main body other than the unit, whereby the unit is held so as to be swingable in such a range that the restricting bolt contacts both ends of the guide slit.

20. The cutting machine according to claim 1, wherein
a portion of the main body other than the unit is a blade case that covers the cutting blade.

21. The cutting machine according to claim 3, wherein
the biasing member is a torsion spring.

22. The cutting machine according to claim 4, wherein
the biasing member is a torsion spring.

23. The cutting machine according to claim 5, wherein
the biasing member is a torsion spring.

24. The cutting machine according to claim 6, wherein
the biasing member is a torsion spring.

25. The cutting machine according to claim 7, wherein
the handle has a grip portion formed at its front end.

26. The cutting machine according to claim 10, wherein
the blade case is provided with a safety cover that covers a lower part of the cutting blade when the main body is located at an upper limit position.
